(19) United States
(12) Patent Application Publication
(10) Pub. No.: US 2026/0227252 A1
(43) Pub. Date: Aug. 6, 2026

(54) PROFILE TO OPTIMIZE STRAIN DISTRIBUTION IN A STRAIN PLATE

(71) Applicant: Schaeffler Technologies AG & Co. KG, Herzogenaurach (DE)

(72) Inventor: Andrew Dyer, Charlotte, NC (US)

(21) Appl. No.: 19/043,863

(22) Filed: Feb. 3, 2025

(51) Int. Cl. G01L 1/22

(52) U.S. Cl. CPC G01L 1/2237

(57) ABSTRACT

A strain plate may be annular or monolithic. The strain plate may include a circumferential groove. The circumferential groove may be formed to provide good linearity and sensitivity to axial loads for a strain gauge circuit affixed to the strain plate. The strain gauge circuit may be affixed to a radial surface opposed to and radially aligned with the circumferential groove. The topology of may create a relative uniform positive and negative strain across the radial surface.

### TECHNICAL FIELD

The present disclosure generally relates to measuring a force, and more particularly, to ring-shaped supports adapted for measuring a force.

### BACKGROUND

It is a challenge to provide a strain measurement across a broad surface of a ring-shaped support that maintains a good linearity and sensitivity to various load conditions. Therefore, it would be advantageous to provide a device, system, and method that cures the shortcomings described above.

### SUMMARY

A strain plate is described, in accordance with one or more aspects of the present disclosure. The strain plate may include: an outer axial surface; a bottom radial surface; and a top radial surface, wherein the outer axial surface axially extends between and couples the bottom radial surface and the top radial surface, wherein the top radial surface defines: a radially-outer top radial surface; and a circumferential groove, wherein the circumferential groove is disposed radially inwards of the radially-outer top radial surface, wherein the circumferential groove is axially offset from the radially-outer top radial surface towards the bottom radial surface, wherein the circumferential groove includes: a radially-inner tapered portion; a minimum-material portion; and a radially-outer tapered portion, wherein the minimum-material portion is radially disposed between the radially-inner tapered portion and the radially-outer tapered portion and is axially disposed between the bottom radial surface and both the radially-inner tapered portion and the radially-outer tapered portion.

In some aspects, the outer axial surface, the bottom radial surface, and the top radial surface are concentric.

In some aspects, the outer axial surface is cylindrical.

In some aspects, the bottom radial surface is planar.

In some aspects, the strain plate is configured as an annular strain plate, wherein the annular strain plate comprises an inner axial surface and a radially-inner top radial surface, wherein the circumferential groove is radially disposed between the radially-inner top radial surface and the radially-outer top radial surface, wherein the radially-inner top radial surface extends radially outwards from the inner axial surface, wherein the radially-inner tapered portion is axially and radially disposed between the radially-inner top radial surface and the minimum-material portion.

In some aspects, the radially-inner top radial surface and the radially-outer top radial surface are planar.

In some aspects, the radially-inner top radial surface is axially aligned with the radially-outer top radial surface.

In some aspects, the strain plate is configured as a monolithic strain plate, wherein the monolithic strain plate comprises a stem portion and an eyelet portion, wherein the circumferential groove is disposed radially outwards of the stem portion, wherein the stem portion axially extend between and couples the radially-inner tapered portion and the eyelet portion, wherein the eyelet portion defines a through hole, wherein the through hole is defined radially through the eyelet portion.

In some aspects, the radially-outer top radial surface extends radially inwards from the outer axial surface.

In some aspects, the radially-inner tapered portion or the radially-outer tapered portion are conical-tapers.

In some aspects, an entry slope of the radially-inner tapered portion is greater than an exit slope of the radially-outer tapered portion.

In some aspects, the radially-inner tapered portion and the radially-outer tapered portion are formed up to a same axial depth in the strain plate.

In some aspects, the minimum-material portion is a concave-curved portion.

In some aspects, the circumferential groove includes a stepped-shoulder portion.

In some aspects, the radially-outer tapered portion is axially and radially disposed between the minimum-material portion and the stepped-shoulder portion, wherein the stepped-shoulder portion is axially and radially disposed between the radially-outer top radial surface and the radially-outer tapered portion.

In some aspects, the strain plate is formed from aluminum or an alloy thereof.

A sensor assembly is described, in accordance with one or more aspects of the present disclosure. The sensor assembly may include: a strain plate including: an outer axial surface; a bottom radial surface; and a top radial surface, wherein the outer axial surface axially extends between and couples the bottom radial surface and the top radial surface, wherein the top radial surface defines: a radially-outer top radial surface; and a circumferential groove, wherein the circumferential groove is disposed radially inwards of the radially-outer top radial surface, wherein the circumferential groove is axially offset from the radially-outer top radial surface towards the bottom radial surface, wherein the circumferential groove includes: a radially-inner tapered portion; a minimum-material portion; and a radially-outer tapered portion, wherein the minimum-material portion is radially disposed between the radially-inner tapered portion and the radially-outer tapered portion and is axially disposed between the bottom radial surface and both the radially-inner tapered portion and the radially-outer tapered portion; and a strain gauge circuit, wherein the strain gauge circuit is affixed to the bottom radial surface, wherein the strain gauge circuit includes one or more strain gauges, wherein the one or more strain gauges are radially aligned with the circumferential groove.

In some aspects, the circumferential groove includes a stepped-shoulder portion.

A system is described, in accordance with one or more aspects of the present disclosure. The system may include: a strain plate including: an outer axial surface; a bottom radial surface; and a top radial surface, wherein the outer axial surface axially extends between and couples the bottom radial surface and the top radial surface, wherein the top radial surface defines: a radially-outer top radial surface; and a circumferential groove, wherein the circumferential groove is disposed radially inwards of the radially-outer top radial surface, wherein the circumferential groove is axially offset from the radially-outer top radial surface towards the bottom radial surface, wherein the circumferential groove includes: a radially-inner tapered portion; a minimum-material portion; and a radially-outer tapered portion, wherein the minimum-material portion is radially disposed between the radially-inner tapered portion and the radially-outer tapered portion and is axially disposed between the bottom radial surface and both the radially-inner tapered portion and the radially-outer tapered portion; and a strain gauge circuit, wherein the strain gauge circuit is affixed to the bottom radial surface, wherein the strain gauge circuit includes one or more strain gauges, wherein the one or more strain gauges are radially aligned with the circumferential groove; and and a radially-outer assembly, wherein the radially-outer assembly is affixed to the strain plate.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the description and drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1A depicts perspective view of a strain plate configured as an annular strain plate, in accordance with one or more embodiments of the present disclosure.

FIG. 1B depicts a top view of the annular strain plate, in accordance with one or more embodiments of the present disclosure.

FIG. 1C depicts a section view of the annular strain plate, in accordance with one or more embodiments of the present disclosure.

FIG. 1D depicts a bottom view of the annular strain plate, in accordance with one or more embodiments of the present disclosure.

FIG. 2A depicts a bottom view of a sensor assembly including the annular strain plate, in accordance with one or more embodiments of the present disclosure.

FIG. 2B depicts a section view of the sensor assembly including the annular strain plate, in accordance with one or more embodiments of the present disclosure.

FIG. 3 depicts a partial section view of a system including the sensor assembly, in accordance with one or more embodiments of the present disclosure.

FIG. 4 depicts a graph including a plot of radial strain of the annular strain plate, in accordance with one or more embodiments of the present disclosure.

FIG. 5A depicts a perspective view of the strain plate configured as a monolithic strain plate, in accordance with one or more embodiments of the present disclosure.

FIG. 5B depicts a top view of the monolithic strain plate, in accordance with one or more embodiments of the present disclosure.

FIG. 5C depicts a section view of the monolithic strain plate, in accordance with one or more embodiments of the present disclosure.

FIG. 5D depicts a bottom view of the monolithic strain plate, in accordance with one or more embodiments of the present disclosure.

FIG. 6 depicts a bottom view of the sensor assembly including the monolithic strain plate, in accordance with one or more embodiments of the present disclosure.

FIG. 7 depicts a partial section view of a system including the sensor assembly, in accordance with one or more embodiments of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Embodiments of the present disclosure are directed to a profile to optimize strain distribution in a strain plate. The strain plate may be annular or monolithic. The strain plate may include a profile including a circumferential groove. The circumferential groove may be formed to provide good linearity and sensitivity to axial loads for a strain gauge circuit affixed to the strain plate. The strain gauge circuit may be affixed to a radial surface opposed to and radially aligned with the circumferential groove. The topology of may create a relative uniform positive and negative strain across the radial surface.

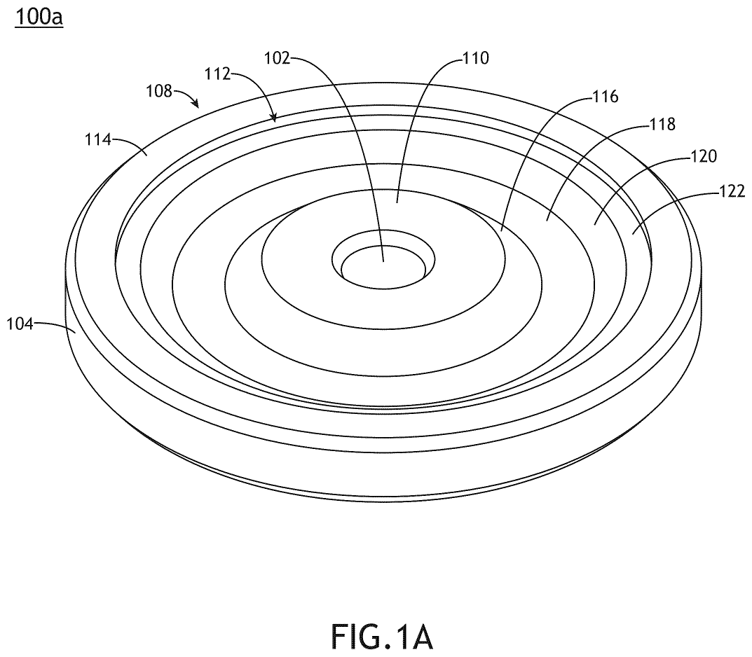

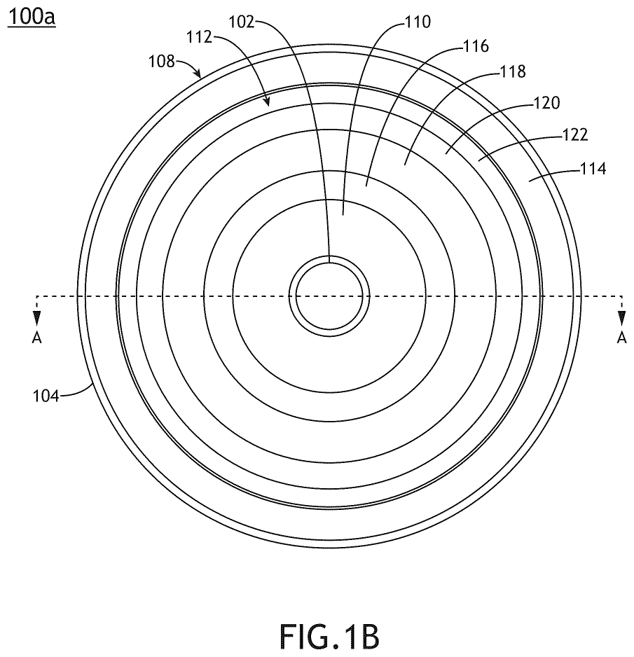

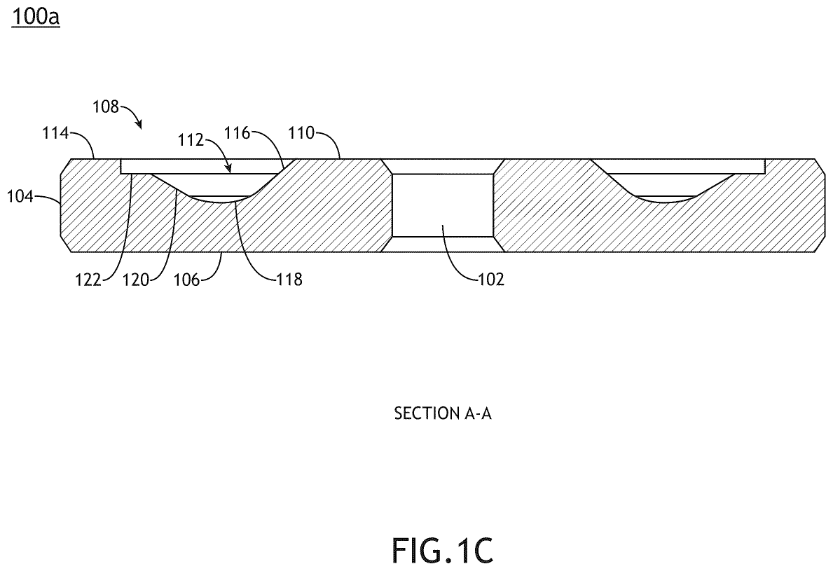

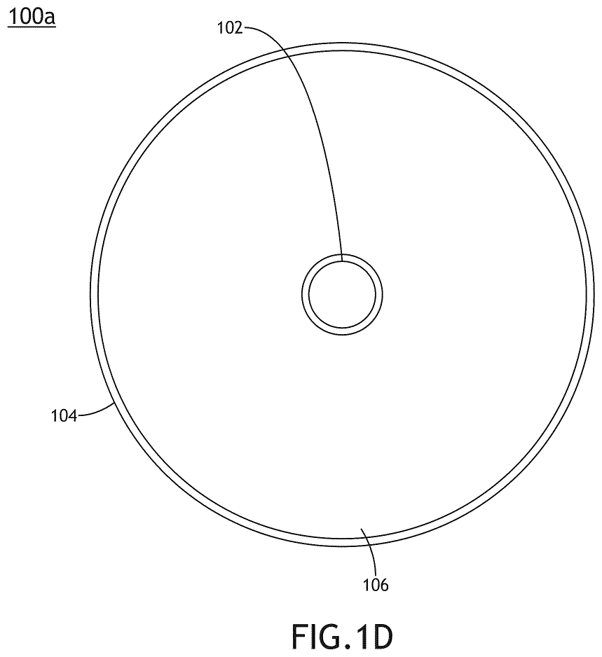

FIGS. 1A-1D depict a strain plate 100, in accordance with one or more embodiments of the present disclosure. The strain plate 100 may be an annular strain plate 100a and/or a monolithic strain plate 100b. The strain plate 100 may include one or more surfaces. For example, the strain plate 100 may include an inner axial surface 102, an outer axial surface 104, a bottom radial surface 106, and/or a top radial surface 108. The top radial surface 108 may define a radially-inner top radial surface 110, circumferential groove 112, and/or a radially-outer top radial surface 114.

The annular strain plate 100a may be annular-shaped with a through hole coaxial with a center axis of the annular strain plate 100a. The annular strain plate 100a may be revolved about the center axis.

The inner axial surface 102, the outer axial surface 104, the bottom radial surface 106, the top radial surface 108, the radially-inner top radial surface 110, circumferential groove 112, and/or the radially-outer top radial surface 114 may be concentric to the center axis.

The inner axial surface 102 and/or the outer axial surface 104 may axially extend along the center axis. The inner axial surface 102 and the outer axial surface 104 may be the radially innermost surface and radially outermost surface, respectively, of the strain plate 100.

The inner axial surface 102 and/or the outer axial surface 104 may be cylindrical. An inner diameter and outer diameter of the strain plate 100 may be defined by the inner axial surface 102 and the outer axial surface 104, respectively. For example, the inner axial surface 102 may define the through hole of the strain plate 100.

The bottom radial surface 106 and the top radial surface 108 may radially extend from the center axis. The bottom radial surface 106 and the top radial surface 108 may be the axial topmost surface and axial bottommost surface, respectively, of the strain plate 100.

The bottom radial surface 106 and the top radial surface 108 may include a select shape. For example, the bottom radial surface 106, the radially-inner top radial surface 110, and/or the radially-outer top radial surface 114 may be planar. The bottom radial surface 106, the radially-inner top radial surface 110, and/or the radially-outer top radial surface 114 may be flat along horizontal planes which are perpendicular to the center axis. The bottom radial surface 106, the radially-inner top radial surface 110, and/or the radially-outer top radial surface 114 may not include any significant curvature along the horizontal planes.

The inner axial surface 102 and/or the outer axial surface 104 may axially extend between and couple the bottom radial surface 106 and the top radial surface 108. Similarly, the bottom radial surface 106 and the top radial surface 108 may radially extend between and couple the inner axial surface 102 and the outer axial surface 104.

The inner axial surface 102 and/or the outer axial surface 104 may be coupled with the bottom radial surface 106 and the top radial surface 108 by one or more edges. The edges may include any suitable edges, such as, but not limited to, beveled edges, filleted edges, or the like.

The radially-inner top radial surface 110 may extend radially outwards from the inner axial surface 102. Similarly, the radially-outer top radial surface 114 may extend radially inwards from the outer axial surface 104. The circumferential groove 112 may be disposed radially inwards of the radially-outer top radial surface 114 and/or disposed radially outwards of the radially-inner top radial surface 110. For example, the circumferential groove 112 may be radially disposed between the radially-inner top radial surface 110 and the radially-outer top radial surface 114.

The top radial surface 108 may be axially separated from the bottom radial surface 106, such that the strain plate 100 may include an axial thickness. The axial thickness of the strain plate 100 may not be uniform at various radial positions from the center axis. The circumferential groove 112 may be axially offset from the radially-inner top radial surface 110 and/or the radially-outer top radial surface 114 towards the bottom radial surface 106. For example, the axial thickness may be lowest at radial positions aligned with the circumferential groove 112 and may be highest at radial positions aligned with the radially-inner top radial surface 110 and/or the radially-outer top radial surface 114.

The radially-inner top radial surface 110 and the radially-outer top radial surface 114 may or may be not be axially aligned. In embodiments, the radially-inner top radial surface 110 and the radially-outer top radial surface 114 are axially aligned and coplanar. The axial thicknesses of the strain plate 100 between the bottom radial surface 106 and the radially-inner top radial surface 110 and between the bottom radial surface 106 and the radially-outer top radial surface 114 may be the same where the radially-inner top radial surface 110 and the radially-outer top radial surface 114 are axially aligned.

The circumferential groove 112 may include a select shape. For example, the circumferential groove 112 may include a radially-inner tapered portion 116, a minimum-material portion 118, a radially-outer tapered portion 120, and/or a stepped-shoulder portion 122.

The radially-inner tapered portion 116 and the radially-outer tapered portion 120 may include any suitable taper. For example, the radially-inner tapered portion 116 and the radially-outer tapered portion 120 may be conical-tapers. The conical-tapers may include a slope along the radially-inner tapered portion 116 and the radially-outer tapered portion 120. The slopes may also be referred to as a lead angle. The slopes of the radially-inner tapered portion 116 and the radially-outer tapered portion 120 may be an entry slope and an exit slope, respectively. The slopes of the radially-inner tapered portion 116 and the radially-outer tapered portion 120 may or may not be the same. For example, the entry slope of the radially-inner tapered portion 116 may be greater than the exit slope of the radially-outer tapered portion 120. The radially-inner tapered portion 116 and the radially-outer tapered portion 120 may also be formed up to a same axial depth in the strain plate 100. The radially-inner tapered portion 116 and the radially-outer tapered portion 120 may be formed up to the same axial depth where the entry slope is greater than the exit slope via the addition of the stepped-shoulder portion 122 and/or by the radially-outer tapered portion 120 being wider than the radially-inner tapered portion 116.

The minimum-material portion 118 may be define a portion of the strain plate 100 with a minimum material thickness between the bottom radial surface 106 and the top radial surface 108. The minimum-material portion 118 may include a select shape. For example, the minimum-material portion 118 may be a concave-curved portion (as depicted) or a stepped-shoulder portion. The minimum-material portion 118 being the concave-curved portion may provide an improve strain behavior as compared to being the stepped-shoulder portion. In embodiments, the minimum-material portion 118 is the concave-curved portion. The concave-curved portion may include a select curvature.

The stepped-shoulder portion 122 may also be referred to as an exit plateau. The stepped-shoulder portion 122 may be planar. Although the circumferential groove 112 are described as including the stepped-shoulder portion 122, this is not intended as a limitation of the present disclosure. The circumferential groove 112 may be formed without the stepped-shoulder portion 122.

The radially-inner tapered portion 116 may be disposed radially inwards of the minimum-material portion 118. The radially-inner tapered portion 116 may be disposed radially outwards of the radially-inner top radial surface 110. The radially-inner tapered portion 116 may be axially and radially disposed between the radially-inner top radial surface 110 and the minimum-material portion 118. The minimum-material portion 118 may be radially disposed between the radially-inner tapered portion 116 and the radially-outer tapered portion 120 and may be axially disposed between the bottom radial surface 106 and both the radially-inner tapered portion 116 and the radially-outer tapered portion 120. The radially-outer tapered portion 120 may be axially and radially disposed between the minimum-material portion 118 and the stepped-shoulder portion 122. The stepped-shoulder portion 122 may be axially and radially disposed between the radially-outer top radial surface 114 and the radially-outer tapered portion 120.

The strain plate 100 may be made of a select material. For example, the strain plate 100 may be aluminum, an alloy thereof, or the like.

The strain plate 100 may be monolithic. In this regard, the strain plate 100 may a single piece which is not formed of halves or other constituent pieces. The strain plate 100 may be filled by the material between the inner axial surface 102, the outer axial surface 104, the bottom radial surface 106, and the top radial surface 108. The strain plate 100 may be fabricated by a manufacturing process, such as, but not limited to, a turning process (e.g., face grooving).

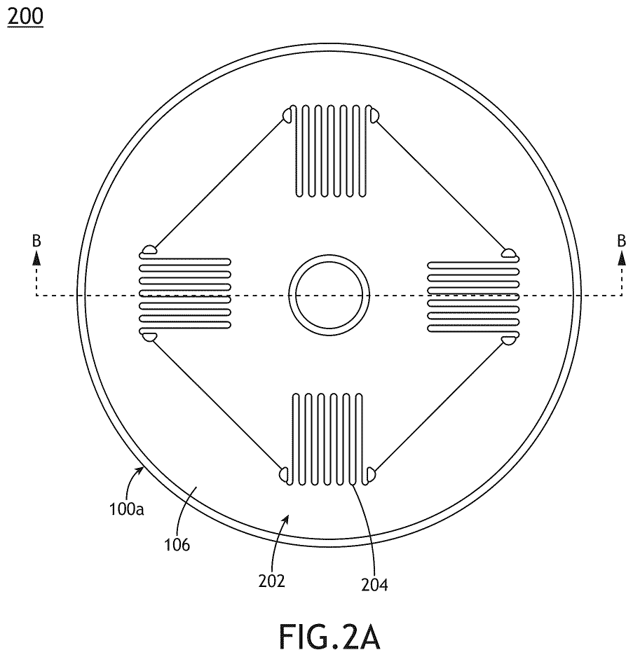

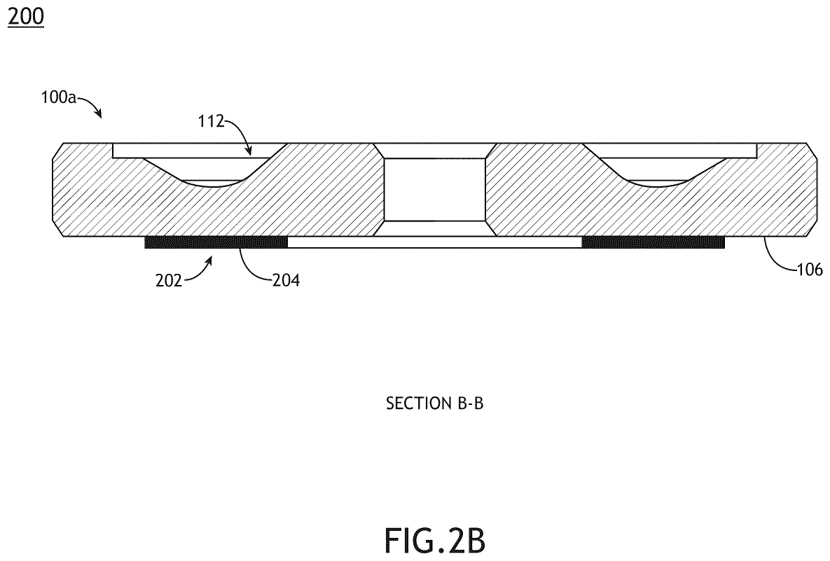

FIGS. 2A-2B depict a sensor assembly 200, in accordance with one or more embodiments of the present disclosure. The sensor assembly 200 may include the strain plate 100 and a strain gauge circuit 202. For example, the sensor assembly 200 may include the annular strain plate 100a and/or the monolithic strain plate 100b. As depicted, the sensor assembly 200 includes the annular strain plate 100a.

The strain gauge circuit 202 may be affixed to the bottom radial surface 106 of the strain plate 100. For example, the strain gauge circuit 202 may be fixed directly on the bottom radial surface 106. The strain gauge circuit 202 may be formed in any suitable manner. For example, the strain gauge circuit 202 may be formed by depositing an electrically conductive material directly on the bottom radial surface 106.

The strain gauge circuit 202 may measure a strain of the strain plate 100 caused by deflection of the strain plate 100. The strain measured by the strain gauge circuit 202 may indicate an axial force inducing the deflection. The strain gauge circuit 202 may include strain gauges 204 for measuring the strain. The strain gauges 204 may be arranged in a pattern which is sensitive to the strain of the strain plate 100. The strain gauges 204 may be radially aligned with the circumferential groove 112. For example, the strain gauges 204 may be radially aligned with the radially-inner tapered portion 116, the minimum-material portion 118, the radially-outer tapered portion 120, and/or the stepped-shoulder portion 122 of the circumferential groove 112. The strain gauge circuit 202 may include any suitable strain gauge for measuring the strain of the strain plate 100. For example, the strain gauge circuit 202 may include, but is not limited to, a foil gauge, a piezo-resistor, or the like. The strain gauge circuit 202 may measure the strain of the strain plate 100 by a change in resistance and/or capacitance of the strain gauge circuit 202. The strain gauges 204 may be disposed radially outwards of the inner axial surface 102 of the annular strain plate 100a.

The strain gauge circuit 202 may be arranged to form any suitable electrical circuit. For example, the strain gauge circuit 202 may form a Wheatstone bridge or the like.

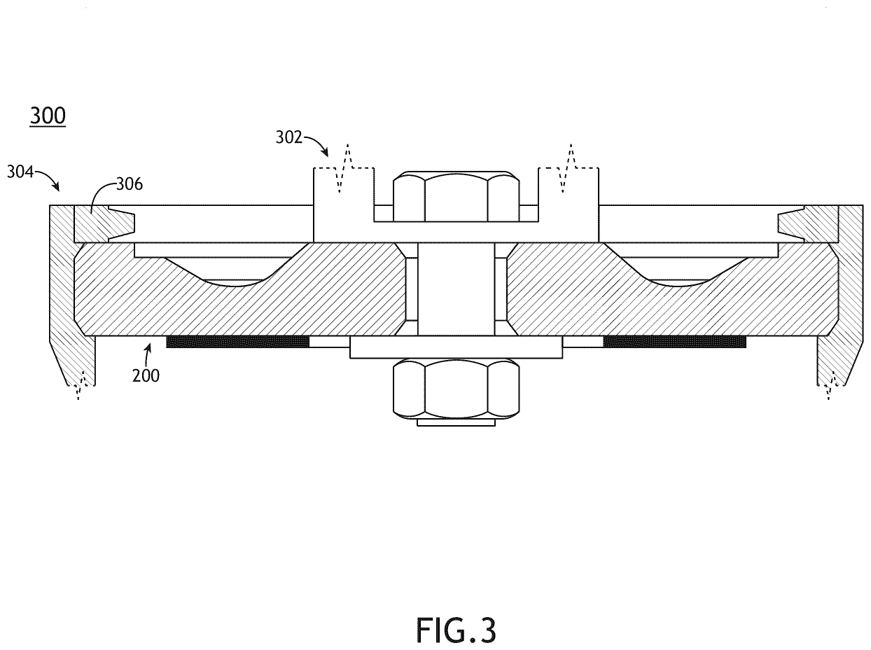

FIG. 3 depicts a system 300, in accordance with one or more embodiments of the present disclosure. The system 300 may include the sensor assembly 200, a radially-inner assembly 302, a radially-outer assembly 304, and/or a spanner 306. The strain plate 100 may couple between the radially-inner assembly 302 and the radially-outer assembly 304. The radially-inner assembly 302 may exert an axial force on the radially-outer assembly 304 through the strain plate 100, and vice versa. The strain gauge circuit 202 may measure the axial force exerted through the strain plate 100 between the radially-inner assembly 302 and the radially-outer assembly 304. The sensor assembly 200 may be a ring-shaped support for measuring force along the axial direction.

The radially-inner assembly 302 and/or the radially-outer assembly 304 may be affixed to the strain plate 100. The radially-inner assembly 302 and/or the radially-outer assembly 304 may be affixed to the inner radius and the outer radius, respectively, of the strain plate 100. The radially-inner assembly 302 and/or the radially-outer assembly 304 may be affixed to the strain plate 100 in any suitable manner, such as, but not limited to, clamp joints, screw joints, weld joints, press fit joints, or the like. For example, the radially-inner assembly 302 may be affixed by clamping between the bottom radial surface 106 and radially-inner top radial surface 110. By way of another example, the radially-outer assembly 304 may be affixed to the strain plate 100 by clamping between the bottom radial surface 106 and the radially-outer top radial surface 114. In embodiments, the radially-outer assembly 304 may be affixed to the strain plate 100 by a spanner 306. The spanner 306 may be a nut or the like. The spanner 306 may thread into the radially-outer assembly 304 and clamp down on the sensor assembly 200, thus preventing the sensor assembly 200 from moving axially and/or radially relative to the radially-outer assembly 304. The radially-inner top radial surface 110 and the radially-outer top radial surface 114 may act as flanges from which to affix the radially-inner assembly 302 and the radially-outer assembly 304, respectively. Although the radially-inner assembly 302 and/or the radially-outer assembly 304 are described as being affixed to the strain plate 100 by clamping, this is not intended as a limitation of the present disclosure. It is contemplated that the inner axial surface 102 and/or the outer axial surface 104 may define an internal thread and an external thread, respectively, by which the screw joint may be formed.

It is contemplated that the system 300 may be used in a variety of applications. For example, one application of the system 300 may be within an end effector of a robot for measuring the axial force on the end effector. The radially-inner assembly 302 and the radially-outer assembly 304 may be the end effector and the joint for the end effector, respectively. The strain measured by the strain gauge circuit 202 may provide force feedback for controlling the end effector and/or the joint. For example, the radially-outer assembly 304 may form a portion of a limb joint of a bipedal robot.

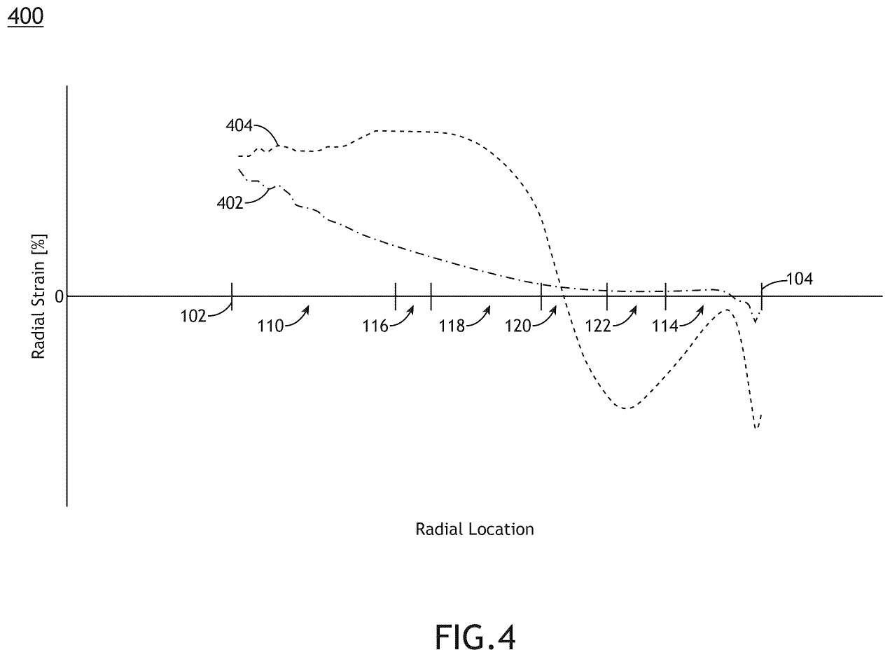

FIG. 4 depicts a graph 400, in accordance with one or more embodiments of the present disclosure. The graph 400 depicts radial strain [%] of the annular strain plate 100a as a function of radial location, where the radial strain is measured from the bottom radial surface 106. Positive radial strains and negative radial strains may indicate the material is increasing and decreasing, respectively, in length in the radial direction. The strain gauge circuit 202 may measure an absolute difference between the positive radial strains and the negative radial strains.

The graph 400 includes a plot 402 and a plot 404. The plot 402 depicts the radial strain along the radius of the annular strain plate 100a without the circumferential groove 112. The plot 404 depicts the radial strain along the radius of the annular strain plate 100a with the circumferential groove 112. The x-axis of the graph 400 starts at the center axis of the annular strain plate 100a. The radial strain of the plot 402 and the plot 404 start from the inner axial surface 102 and extends through to the outer axial surface 104. The radial strain of the plot 402 starts positive at the inner axial surface 102 and approaches to zero at the outer axial surface 104 via a reciprocal function, or similar. The radial strain of the plot 404 starts positive at the inner axial surface 102, may maintain a relative constant positive radial strain along the radially-inner top radial surface 110, the radially-inner tapered portion 116, and/or the minimum-material portion 118, decrease from the positive radial strain to a negative radial strain along the radially-outer tapered portion 120 with an inflection point near a middle of the radially-outer tapered portion 120, and increase from the negative radial strain to a near zero radial strain along the stepped-shoulder portion 122 and the radially-outer top radial surface 114. As illustrated by the plot 402 and the plot 404, the circumferential groove 112 may increase the magnitude of the radial strain along the annular strain plate 100a, thereby increasing the sensitivity of the strain gauge circuit 202. Furthermore, the uniformity of the strain along the radially-inner top radial surface 110, the radially-inner tapered portion 116, and/or the minimum-material portion 118 may be improved. The stepped-shoulder portion 122 may be advantageous to modify the strain after the inflection point.

The circumferential groove 112 may provide a profile to optimize strain distribution in the annular strain plate 100a. The features of the circumferential groove 112 influences the strain behavior on the bottom radial surface 106 to change from the flat plate strain response to a more optimized strain response. The circumferential groove 112 may provide a good sensitivity and linearity to the bottom radial surface 106 which is exposed to uneven strain distribution. Radially aligning the strain gauges 204 with the circumferential groove 112 together with the shape of the circumferential groove 112 may provide a select strain response. The slopes of the radially-inner tapered portion 116 and/or the radially-outer tapered portion 120 and/or the curvature of the minimum-material portion 118 may be selected to optimize the strain and/or improve the ease-of-manufacturing of the annular strain plate 100a.

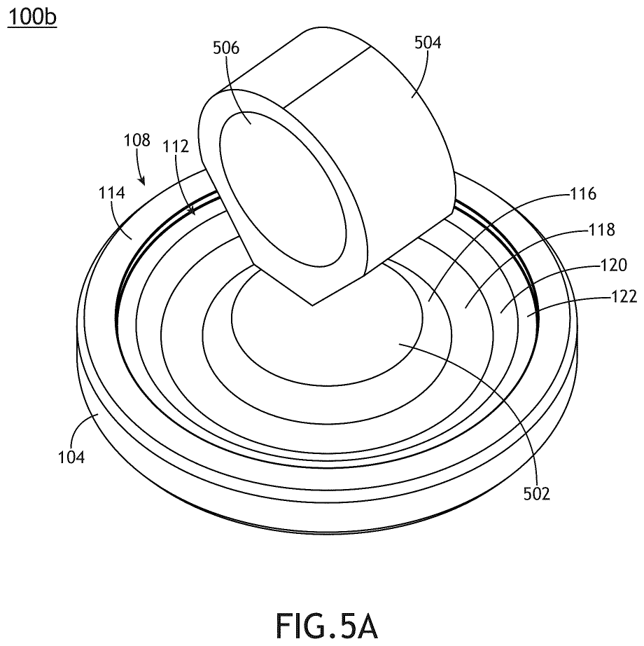

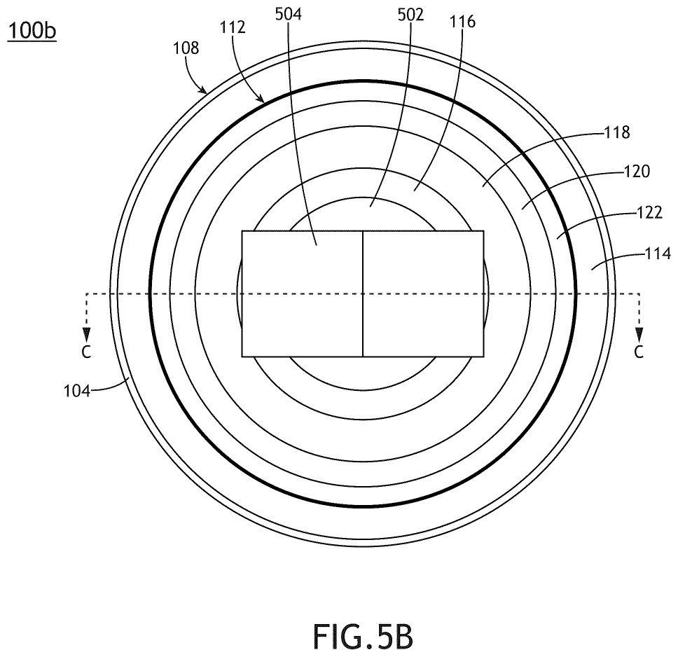

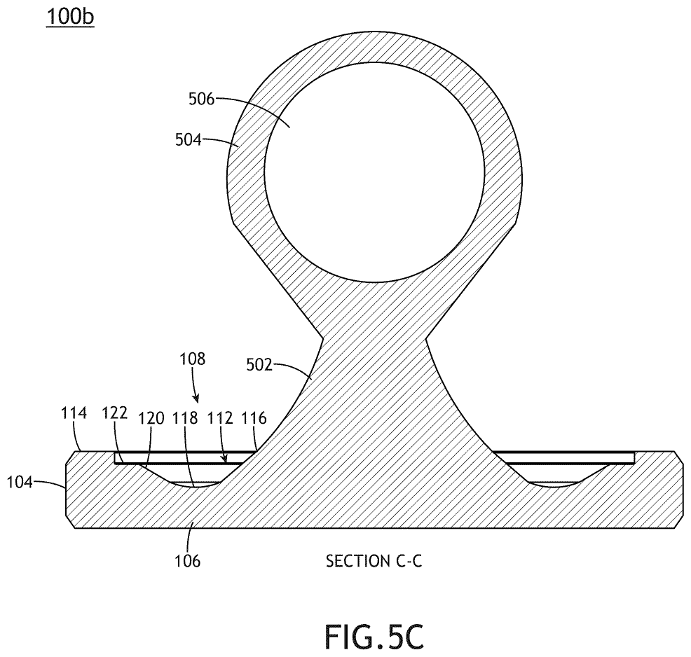

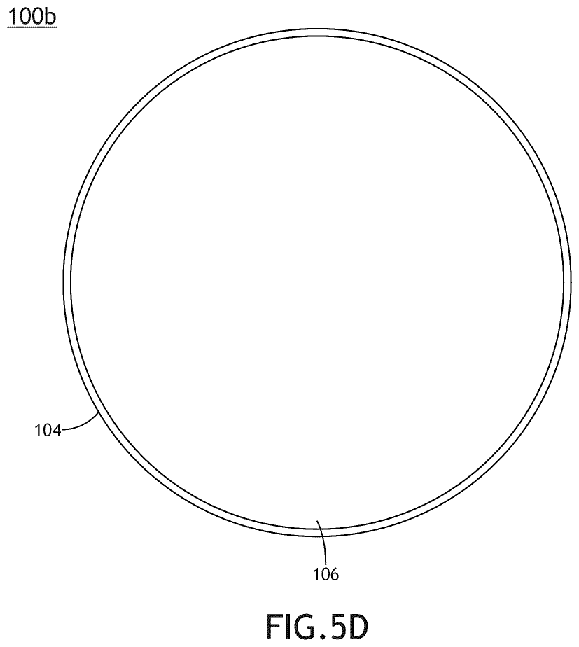

FIGS. 5A-5D depict the monolithic strain plate 100b, in accordance with one or more embodiments of the present disclosure. The discussion of the annular strain plate 100a is incorporated herein by reference as to the monolithic strain plate 100b, with the exception that the monolithic strain plate 100b does not include the inner axial surface 102. The monolithic strain plate 100b may or may not include the radially-inner top radial surface 110. For example, the radially-inner top radial surface 110 is depicted without the radially-inner top radial surface 110. The monolithic strain plate 100b may include the outer axial surface 104, the bottom radial surface 106, the top radial surface 108, the circumferential groove 112, the radially-outer top radial surface 114, the radially-inner tapered portion 116, the minimum-material portion 118, the radially-outer tapered portion 120, and/or the stepped-shoulder portion 122. The bottom radial surface 106 may be flat across the radial width of the monolithic strain plate 100b without defining the inner axial surface 102 (e.g., a through hole). The monolithic strain plate 100b may include a stem portion 502 and/or an eyelet portion 504.

The stem portion 502 may be a curved surface. The stem portion 502 may be revolved about the center axis of the monolithic strain plate 100b. The stem portion 502 may include a select diameter. The diameter of the stem portion 502 may strongly affect the location of the strain inflection point along the bottom radial surface 106.

The circumferential groove 112 may be disposed radially outwards of the stem portion 502. For example, the circumferential groove 112 may be radially disposed between the stem portion 502 and the radially-outer top radial surface 114. The stem portion 502 may axially extend from the radially-inner tapered portion 116. The radially-inner tapered portion 116 may be disposed radially outwards of the stem portion 502. The radially-inner tapered portion 116 may be axially and radially disposed between the stem portion 502 and the minimum-material portion 118. A slope of the radially-inner tapered portion 116 and/or the stem portion 502 may control strain uniformity along the bottom radial surface 106.

The eyelet portion 504 may axially extend from the stem portion 502. The stem portion 502 may axially extend between and couple the radially-inner tapered portion 116 and the eyelet portion 504. The bottom radial surface 106, the stem portion 502, and/or the eyelet portion 504 may be radially aligned.

The eyelet portion 504 may define a through hole 506. The through hole 506 may be defined radially through the eyelet portion 504. The through hole 506 may be perpendicular to the center axis of the monolithic strain plate 100b.

One advantage of the annular strain plate 100a, as compared to the monolithic strain plate 100b, may be the ease of manufacture of the annular strain plate 100 a. For example, the monolithic strain plate 100 b may require a 5-axis and/or a 6-axis lathe to turn the joint between the radially-inner tapered portion 116 and the stem portion 502 with sufficient clearance for a bit of the lathe. The annular strain plate 100 a may be turned with less complex machining, such as a 4-axis lathe or the like.

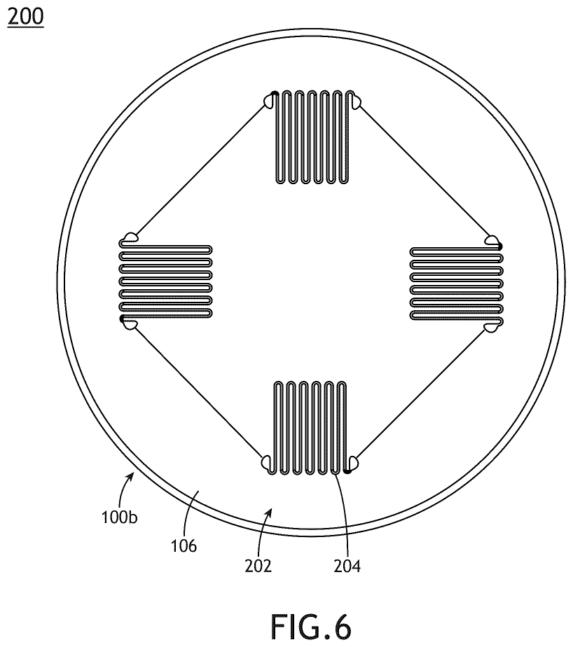

FIG. 6 depicts the sensor assembly 200, in accordance with one or more embodiments of the present disclosure. The discussion of using the annular strain plate 100a in the sensor assembly 200 with the strain gauge circuit 202 is incorporated herein by reference as to the monolithic strain plate 100b. The sensor assembly 200 may include the monolithic strain plate 100b with the strain gauge circuit 202 affixed to the bottom radial surface 106 of the monolithic strain plate 100b. One advantage of the monolithic strain plate 100b in the sensor assembly 200, as compared to the annular strain plate 100a, may be that the monolithic strain plate 100b has additional area for the strain gauge circuit 202. For example, the strain gauge circuit 202 may cover (not depicted) the center axis of the monolithic strain plate 100b but may not cover the center axis of the annular strain plate 100a due to the inner axial surface 102.

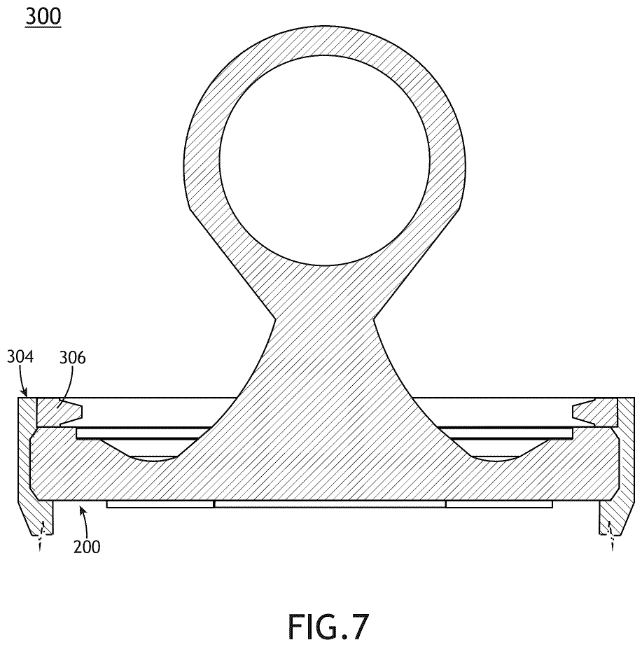

FIG. 7 depicts the system 300, in accordance with one or more embodiments of the present disclosure. The discussion of using the sensor assembly 200 with the annular strain plate 100a in the system 300 is incorporated herein by reference as to using the sensor assembly 200 with the monolithic strain plate 100b. The system 300 may use the sensor assembly 200 with the monolithic strain plate 100b. The stem portion 502 and the eyelet portion 504 may replace the functionality of the radially-inner assembly 302. For example, the radially-inner assembly 302 may be an eyelet for coupling to an end effector. The eyelet portion 504 may enable coupling with the end effector. Thus, the system 300 may or may not include the radially-inner assembly 302. The strain gauge circuit 202 may measure the measure the axial force exerted through the strain plate 100 between the radially-inner assembly 302 and the eyelet portion 504.

One skilled in the art will recognize that the herein described components operations, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components, operations, devices, and objects should not be taken as limiting.

As used herein, the term “axial” and derivatives thereof, such as “axially,” shall be understood to refer to a direction along the axis. The term “coaxial” shall be understood to refer to a common axis. Further, the term “radial” and derivatives thereof, such as “radially,” shall be understood in relation to the axis. For example, “radially outward” refers to further away from the axis, while “radially inward” refers to nearer to the axis. The term “circumference” or derivatives thereof, such as “circumferentially”, may also be defined in reference to the center axis.

As used herein, directional terms such as “top,” “bottom,” “over,” “under,” “upper,” “upward,” “lower,” “down,” and “downward” are intended to provide relative positions for purposes of description, and are not intended to designate an absolute frame of reference. Various modifications to the described embodiments will be apparent to those with skill in the art, and the general principles defined herein may be applied to other embodiments

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. As such, to the extent any embodiments are described as less desirable than other embodiments or prior art implementations with respect to one or more characteristics, these embodiments are not outside the scope of the disclosure and can be desirable for particular applications.

### LIST OF REFERENCE NUMBERS

100 strain plate
100a annular strain plate
100b monolithic strain plate
102 inner axial surface
104 outer axial surface
106 bottom radial surface
108 top radial surface
110 radially-inner top radial surface
112 circumferential groove
114 radially-outer top radial surface
116 radially-inner tapered portion
118 minimum-material portion
120 radially-outer tapered portion
122 stepped-shoulder portion
200 sensor assembly
202 strain gauge circuit
204 strain gauges
300 system
302 radially-inner assembly
304 radially-outer assembly
306 spanner
400 graph
402 plot
404 plot
502 stem portion
504 eyelet portion
506 through hole

What is claimed:

1. A strain plate comprising:
an outer axial surface;
a bottom radial surface; and
a top radial surface, wherein the outer axial surface axially extends between and couples the bottom radial surface and the top radial surface, wherein the top radial surface defines:
a radially-outer top radial surface; and
a circumferential groove, wherein the circumferential groove is disposed radially inwards of the radially-outer top radial surface, wherein the circumferential groove is axially offset from the radially-outer top radial surface towards the bottom radial surface, wherein the circumferential groove includes:
a radially-inner tapered portion;
a minimum-material portion; and
a radially-outer tapered portion, wherein the minimum-material portion is radially disposed between the radially-inner tapered portion and the radially-outer tapered portion and is axially disposed between the bottom radial surface and both the radially-inner tapered portion and the radially-outer tapered portion.

2. The strain plate of claim 1, wherein the outer axial surface, the bottom radial surface, and the top radial surface are concentric.

3. The strain plate of claim 1, wherein the outer axial surface is cylindrical.

4. The strain plate of claim 1, wherein the bottom radial surface is planar.

5. The strain plate of claim 1, wherein the strain plate is configured as an annular strain plate, wherein the annular strain plate comprises an inner axial surface and a radially-inner top radial surface, wherein the circumferential groove is radially disposed between the radially-inner top radial surface and the radially-outer top radial surface, wherein the radially-inner top radial surface extends radially outwards from the inner axial surface, wherein the radially-inner tapered portion is axially and radially disposed between the radially-inner top radial surface and the minimum-material portion.

6. The strain plate of claim 5, wherein the radially-inner top radial surface and the radially-outer top radial surface are planar.

7. The strain plate of claim 6, wherein the radially-inner top radial surface is axially aligned with the radially-outer top radial surface.

8. The strain plate of claim 1, wherein the strain plate is configured as a monolithic strain plate, wherein the monolithic strain plate comprises a stem portion and an eyelet portion, wherein the circumferential groove is disposed radially outwards of the stem portion, wherein the stem portion axially extends between and couples the radially-inner tapered portion and the eyelet portion, wherein the eyelet portion defines a through hole, wherein the through hole is defined radially through the eyelet portion.

9. The strain plate of claim 1, wherein the radially-outer top radial surface extends radially inwards from the outer axial surface.

10. The strain plate of claim 1, wherein the radially-inner tapered portion or the radially-outer tapered portion are conical-tapers.

11. The strain plate of claim 10, wherein an entry slope of the radially-inner tapered portion is greater than an exit slope of the radially-outer tapered portion.

12. The strain plate of claim 11, wherein the radially-inner tapered portion and the radially-outer tapered portion are formed up to a same axial depth in the strain plate.

13. The strain plate of claim 1, wherein the minimum-material portion is a concave-curved portion.

14. The strain plate of claim 1, wherein the circumferential groove includes a stepped-shoulder portion.

15. The strain plate of claim 14, wherein the radially-outer tapered portion is axially and radially disposed between the minimum-material portion and the stepped-shoulder portion, wherein the stepped-shoulder portion is axially and radially disposed between the radially-outer top radial surface and the radially-outer tapered portion.

16. The strain plate of claim 1, wherein the strain plate is formed from aluminum or an alloy thereof.

17. A sensor assembly comprising:
a strain plate comprising:
an outer axial surface;
a bottom radial surface; and
a top radial surface, wherein the outer axial surface axially extends between and couples the bottom radial surface and the top radial surface, wherein the top radial surface defines:
a radially-outer top radial surface; and
a circumferential groove, wherein the circumferential groove is disposed radially inwards of the radially-outer top radial surface, wherein the circumferential groove is axially offset from the radially-outer top radial surface towards the bottom radial surface, wherein the circumferential groove includes:
a radially-inner tapered portion;
a minimum-material portion; and
a radially-outer tapered portion, wherein the minimum-material portion is radially disposed between the radially-inner tapered portion and the radially-outer tapered portion and is axially disposed between the bottom radial surface and both the radially-inner tapered portion and the radially-outer tapered portion; and
a strain gauge circuit, wherein the strain gauge circuit is affixed to the bottom radial surface, wherein the strain gauge circuit comprises one or more strain gauges, wherein the one or more strain gauges are radially aligned with the circumferential groove.

18. The sensor assembly of claim 17, wherein the one or more strain gauges are radially aligned with the radially-inner tapered portion, the minimum-material portion, and the radially-outer tapered portion.

19. The sensor assembly of claim 18, wherein the circumferential groove includes a stepped-shoulder portion.

20. A system comprising:
a sensor assembly comprising:
a strain plate comprising:
an outer axial surface;
a bottom radial surface; and
a top radial surface, wherein the outer axial surface axially extends between and couples the bottom radial surface and the top radial surface, wherein the top radial surface defines:
a radially-outer top radial surface; and
a circumferential groove, wherein the circumferential groove is disposed radially inwards of the radially-outer top radial surface, wherein the circumferential groove is axially offset from the radially-outer top radial surface towards the bottom radial surface, wherein the circumferential groove includes:
a radially-inner tapered portion;
a minimum-material portion; and
a radially-outer tapered portion, wherein the minimum-material portion is radially disposed between the radially-inner tapered portion and the radially-outer tapered portion and is axially disposed between the bottom radial surface and both the radially-inner tapered portion and the radially-outer tapered portion; and
a strain gauge circuit, wherein the strain gauge circuit is affixed to the bottom radial surface, wherein the strain gauge circuit comprises one or more strain gauges, wherein the one or more strain gauges are radially aligned with the circumferential groove; and
a radially-outer assembly, wherein the radially-outer assembly is affixed to the strain plate.
